(19) United States
(12) Patent Application Publication
(10) Pub. No.: US 2009/0197779 A1
(43) Pub. Date: Aug. 6, 2009

(54) METHOD FOR ENHANCED RECOVERY OF OIL FROM OIL RESERVOIRS

(76) Inventors: SCOTT CHRISTOPHER JACKSON, Wilmington, DE (US); Hari Babu Sunkara, Hockessin, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/023,166

(22) Filed: Jan. 31, 2008

(51) Int. Cl. C09K 8/60

(52) U.S. Cl. 507/204; 507/266

(57) ABSTRACT

The present invention provides a method for recovering oil from a subterranean reservoir using waterflooding, wherein the flooding fluid used in the waterflooding process comprises water and one or more of 1,3-propanediol, oligomers of 1,3-propanediol and polymers of 1,3-propanediol. The use of 1,3-propanediol, oligomers and/or polymers thereof is expected to increase the recovery of oil by improving both the oil/water mobility ratio and the sweep efficiency in reservoirs with a high degree of heterogeneity.

### FIELD OF THE INVENTION

The present invention relates to a process for recovering crude oil from oil reservoirs using a flooding fluid comprising water and one or more of 1,3propanediol, oligomers thereof and/or polymers thereof.

### BACKGROUND OF THE INVENTION

In the recovery of oil from oil-bearing reservoirs, it is typically possible to recover only minor portions of the original oil in place by primary recovery methods which utilize only the natural forces present in the reservoir. Thus a variety of supplemental recovery techniques have been used in order to increase oil recovery. A commonly used secondary technique is waterflooding which involves the injection of water into the oil reservoir. As the water moves through the reservoir, it acts to displace oil therein to one or more production wells through which the oil is recovered.

One problem that can be encountered with waterflooding operations is the relatively poor sweep efficiency of the water, i.e., the water can channel through certain portions of the reservoir as it travels from the injection well(s) to the production well(s), thereby bypassing other portions of the reservoir. Poor sweep efficiency may be due, for example, to differences in the mobility of the water versus that of the oil, and permeability variations within the reservoir which encourage flow through some portions of the reservoir and not others.

Various enhanced oil recovery techniques have been used to improve sweep efficiency. One such technique involves increasing the viscosity of the water using non-biodegradable thickening agents such as polyvinyl aromatic sulfonates as described in U.S. Pat. No. 3,085,063. The present invention provides a method for improving sweep efficiency through the use of cost-effective, bio-based and/or biodegradable materials that exhibit shear-thinning properties and thus exhibit lower viscosity during injection and increased viscosity in the oil reservoir.

### SUMMARY OF THE INVENTION

The present invention relates to the recovery of oil from a subterranean reservoir using waterflooding. In one aspect, the present invention provides a method for recovering oil from a reservoir by waterflooding, comprising:
(a) introducing an aqueous flooding fluid into the reservoir, wherein at least one portion of said flooding fluid comprises one or more members of the group consisting of 1,3-propanediol; an oligomer of 1,3-propanediol; a homopolymer of 1,3-propanediol; and a heteropolymer of 1,3-propanediol, wherein said heteropolymer is synthesized using at least one C₂ through C₁₂ comonomer diol; and
(b) displacing oil in the reservoir with said flooding fluid into one or more production wells, whereby the oil is recoverable.

In another aspect, the present invention provides a method of making a flooding fluid. Further, methods of making biodegradable and readily disposable flooding fluids are provided for use in waterflooding operations.

### BRIEF DESCRIPTION OF THE DRAWING

FIG. 1 shows viscosity as a function of shear for 0.3 weight % Cerenol™ H500 (DuPont de Nemours & Co., Wilmington, Del.) in deionized water.

FIG. 2 shows viscosity as a function of shear for 1 weight % Cerenol™ H500 in deionized water.

FIG. 3 shows viscosity as a function of shear for 1 weight % 1,3-propanediol (DuPont de Nemours & Co.) in deionized water.

FIG. 4 shows viscosity of as a function of shear for 1 weight % Cerenol™ H500 dissolved in synthetic sea water. The synthetic sea water was acquired from EMD Chemicals Inc, Gibbstown N.J., Part number GC0118/1, lot#7050.

FIG. 5 shows viscosity as a function of shear for 0.3 weight % Cerenol™ H500 in synthetic sea water.

FIG. 6 shows viscosity as a function of shear for 0.1 weight % Cerenol™ C500 dipolymer in synthetic sea water.

FIG. 7 shows viscosity as a function of shear for 0.1 weight % Cerenol™ H1150 homopolymer in synthetic sea water.

### DETAILED DESCRIPTION

The present invention relates to the recovery of oil from a subterranean reservoir using waterflooding. Waterflooding is a technique that is commonly used for secondary oil recovery from oil reservoirs. According to this technique, water is injected through one or more wells into the reservoir, and as the water moves through the reservoir, it acts to displace oil therein to one or more production wells through which the oil is recovered. According to the present invention, the efficacy of waterflooding is improved through the use of 1,3-propanediol and/or oligomers or polymers thereof. Thus, in one aspect, the present invention provides a flooding fluid for use in waterflooding operations comprising water, wherein at least one portion of said water comprises one or more members of the group consisting of 1,3-propanediol; an oligomer of 1,3-propanediol; a homopolymer of 1,3-propanediol; and a heteropolymer of 1,3-propanediol, wherein said heteropolymer is synthesized using at least one C₂ through C₁₂ comonomer diol.

In another aspect, the present invention provides a method for recovering oil from a reservoir by waterflooding, comprising:
(a) introducing an aqueous flooding fluid into the reservoir, wherein at least one portion of said flooding fluid comprises one or more members of the group consisting of 1,3-propanediol; an oligomer of 1,3-propanediol; a homopolymer of 1,3-propanediol; and a heteropolymer of 1,3-propanediol, wherein said heteropolymer is synthesized using at least one C₂ through C₁₂ comonomer diol; and
(b) displacing oil in the reservoir with said flooding fluid into one or more production wells, whereby the oil is recoverable.

Production wells are wells through which oil is withdrawn from a reservoir. An oil reservoir or oil formation is a subsurface body of rock having sufficient porosity and permeability to store and transmit oil.

The present invention provides an advantage to existing technology in that the 1,3-propanediol, or oligomers or polymers thereof, can be obtained from renewable resources. Examples of such renewably-sourced materials include Bio-PDO™ and Cerenol™ (a homopolymer of 1,3-propanediol), both of which can be obtained from DuPont de Nemours & Co., Inc., Wilmington, Del. The use of 1,3-propanediol, or oligomers or polymers thereof, is also advantageous in that these compounds are biodegradable, and thus flooding fluid having these compounds can be safely released into the environment surrounding the oil recovery operation if necessary, or as an accidental release. In addition, a flooding fluid comprising these compounds exhibits shear-thinning properties, such that the solution exhibits low viscosity at high shear rates and increased viscosity at low shear rates. As used herein, “shear thinning” refers to the reduction of viscosity of a liquid (such as that portion of the flooding fluid comprising 1,3-propanediol, or oligomers or polymers thereof) under shear stress. “Viscosity” refers to the resistance of a liquid (such as water or oil) to flow.

The flooding fluid useful for waterflooding according to the present invention comprises water and one or more members selected from the group consisting of 1,3-propanediol; an oligomer of 1,3-propanediol; a homopolymer of 1,3-propanediol; and a heteropolymer of 1,3-propanediol, wherein said heteropolymer is synthesized using at least one C₂ through C₁₂ comonomer diol. In the following discussion, “one or more members selected from the group consisting of 1,3-propanediol; an oligomer of 1,3-propanediol; a homopolymer of 1,3-propanediol; and a heteropolymer of 1,3-propanediol, wherein said heteropolymer is synthesized using at least one C₂ through C₁₂ comonomer diol” is also referred to as “1,3-propanediol thickener”. “Water” can be supplied from any suitable source, and can include, for example, sea water, brine, production water, water recovered from an underground aquifer, including those aquifers in contact with the oil, or surface water from a stream, river, pond or lake. As is known in the art, it may be necessary to remove particulates from the water prior to injection into the one or more wells.

1,3-Propanediol (also referred to herein as 1,3-propanediol monomer or monomer of 1,3-propanediol) can be obtained commercially; in one aspect 1,3-propanediol can be derived from fermentation, referred to as “biologically-derived” 1,3-propanediol. Oligomers and polymers (both homopolymers and heteropolymers) of 1,3-propanediol can be prepared by the acid-catalyzed condensation polymerization of 1,3-propanediol as described in U.S. Pat. No. 6,720,459, column 4, line 15 through column 16, line 65.

An “oligomer” of 1,3-propanediol has a degree of polymerization of 2-6, whereas a “polymer” has a degree of polymerization of at least 7. A “homopolymer” of 1,3-propanediol is a polymer synthesized using monomers of 1,3-propanediol. A “heteropolymer” of 1,3-propanediol is a polymer synthesized using 1,3-propanediol monomers as well as one or more additional C₂ through C₁₂ straight-chain or branched comonomer diols. In one aspect, the one or more comonomer diols are selected from the group consisting of 1,2-ethanediol, 2-methyl-1,3-propanediol, 2,2′-dimethyl-1,3-propanediol, 1-6-hexanediol, 1,7-heptanediol, 1,7-octanediol, 1,10-decanediol, and 1,12-dodecanediol. The one or more comonomer diols can comprise up to about 50% by weight relative to the weight of the heteropolymer. In one aspect, the oligomer of 1,3-propanediol, or the homo- or hetero-polymer of 1,3-propanediol, has a molecular weight of about 152 g/mole to about 3000 g/mole. In a more specific aspect, the oligomer of 1,3-propanediol, or the homo- or hetero-polymer of 1,3-propanediol, has a molecular weight of about 300 g/mole to about 1000 g/mole, and in an even more specific aspect, the oligomer of 1,3-propanediol, or the homo- or hetero-polymer of 1,3-propanediol, has a molecular weight of about 400 g/mole to about 700 g/mole. In one aspect, the oligomer or polymer of 1,3-propanediol is Cerenol™.

The flooding fluid useful for the waterflooding process of the invention comprises water, wherein at least a portion of said water comprises 1,3-propanediol as a thickener. Thus, in one aspect, the 1,3-propanediol thickener is added to a volume of water and injected into the well(s), followed by the injection of additional water. This process can be repeated one or more times if necessary. At the injection well(s), which is under high pressure and high shear, the relative viscosity of the at least one portion of the flooding fluid comprising 1,3-propanediol thickener is low, whereas as the at least one portion of the flooding fluid flows into the reservoir, the shear decreases and the relative viscosity increases. The 1,3-propanediol thickener can also be added to the entire volume of flooding fluid, as long as the backpressure at the injection well(s) does not become too high. As is known to those skilled in the art of oil recovery, the bottom well pressure of the injector can not exceed the strength of the rock formation, otherwise formation damage will occur at a given flow rate. Adjustments can be made by reducing the flow of the injection water, adding water to decrease viscosity, or by adding water mixed with 1,3-propanediol thickener to increase viscosity in order to improve the efficacy of oil recovery.

The 1,3-propanediol thickener can be added as a viscous liquid to the at least one portion of the flooding fluid. The concentration of the 1,3-propanediol thickener in the at least one portion of the flooding fluid can be in the range of about 0.007% to about 3% (weight of 1,3-propanediol thickener/total weight of the at least one portion of flooding fluid comprising said 1,3-propanediol thickener). In another aspect, the concentration is in the range of about 0.1% to about 1% (weight/weight).

In one aspect, the 1,3-propanediol thickener is added to flooding fluid in order to increase the viscosity of at least one portion of the water in the flooding fluid, thereby improving the displacement of oil to the production well(s). To achieve optimal efficiency in waterflooding operations, it is desirable that the mobility of the water be less than the mobility of the oil. The “mobility” is the ratio of the permeability to the flow of a liquid to the dynamic viscosity of said liquid (Boatright, K E, 2002, Basic Petroleum Engineering Practices, 9.6; see also Integrated Petroleum Management—A Team Approach, (A. Sattar and G. Thakurm, PennWell Books, Tulsa, Okla., 1994)). The oil mobility is calculated by the formula kₒ/μₒ, where kₒ is the oil permeability and μₒ is the oil dynamic viscosity. Similarly, the water mobility is calculated by k_{w}/μ_{w}, where k_{w} is the water permeability and μ_{w} is the water dynamic viscosity. In typical water flooding operations the water mobility is greater than the oil mobility, thus the water will tend to channel or finger through the oil. When 1,3-propanediol thickener is added to the at least one portion of the flooding fluid as described by aspects of the present invention, the addition of the 1,3-propanediol thickener increases the viscosity of the at least one portion of the water, thereby reducing the effective water mobility. Thus, the oil is more likely to be driven towards the production well(s).

In one aspect, the viscosity of the at least one portion of the flooding fluid comprising 1,3-propanediol thickener is greater than about 2 centipoise at low shear rates, wherein low shear rates are less than about 3 sec⁻¹. In another aspect, the viscosity of the at least one portion of the flooding fluid comprising 1,3-propanediol thickener is less than about 2 centipoise at high shear rates, wherein high shear rates are greater than about 50 sec⁻¹.

In a stratified oil-bearing formation the permeability of different geological oil-bearing layers may differ, which has as a result that injected water will reach the production well initially through the most permeable layer, before a substantial amount of the oil of the other, less permeable, layers is retrieved. This breakthrough of injection water is problematic for oil recovery, as the water/oil ratio retrieved from the production well will increase and become more unfavorable during the lifetime of the oil field. The addition of a 1,3-propanediol thickener to at least one portion of the flooding fluid is expected to result in less water flooding the more permeable zones in a reservoir, thus reducing the chance of fingering of flooding fluid through these more permeable zones of the oil bearing strata and improving sweep efficiency.

Additional materials can optionally be added as thickening agents or surface active agents to enhance the sweep efficiency of the flooding fluid and/or reduce water mobility. These materials include at least one of the group consisting of hay, sugar cane fibers, cotton seed hull, textile fibers, shredded paper, bentonite, rubber pulp, wood shavings and nut hulls, provided that these materials together with the 1,3-propanediol thickener provide the desired viscosity, concentration and/or particle size distribution. In addition, thickeners, such as polyacrylic amide, carboxymethylcellulose, polysaccharide, polyvinyl alcohol, polyvinyl pyrrolidone, polyacyrlic, and polystyrene sulfonates, and ethylene oxide polymers, as described in U.S. Pat. No. 3,757,863, column 2, line 33 to line 54; and methyl cellulose, starch, guar gum, gum tragacanth, sodium alginate, and gum arabic, as described in U.S. Pat. No. 3,421,582, column 2, line 33 to line 45 can be used. Each of the thickeners can be used alone, or in combination with one or more other thickeners as described above. Surfactants, such as acid salts of amido-acids as described in U.S. Pat. No. 2,802,785, column 2, line 11 to column 4, line 43 can also optionally be added. Surfactants and thickeners can also be used in combination. The use of 1,3-propanediol thickener according to the present invention is advantageous in that the 1,3-propanediol thickener is biodegradable and does not present environmental toxicity problems. Thus, in one aspect, the additional materials that are added to flooding fluids of the invention are preferably also biodegradable, such as starch, guar gum, sodium alginate, gum arabic and methyl cellulose.

In one aspect, the present invention provides a method for making an aqueous flooding fluid for use in waterflooding, comprising:
(a) adding one or more members of the group consisting of 1,3-propanediol; an oligomer of 1,3-propanediol; a homopolymer of 1,3-propanediol; and a heteropolymer of 1,3-propanediol, wherein said heteropolymer is synthesized using at least one C₂ through C₁₂ comonomer diol; to at least one portion of water used in waterflooding.

The flooding fluid can be recovered as it exits the production well(s) and at least one portion of said flooding fluid can be reused, i.e., injected, into the reservoir. Prior to reinjection into the reservoir, additional 1,3-propanediol thickener can be added to at least one portion of the recovered flooding fluid. Additional 1,3-propanediol thickener can be added at a concentration of about 0.007% to about 3% (weight of 1,3-propanediol thickener/weight of the at least one portion of flooding fluid). Alternatively, at least one portion of the flooding fluid exiting the production well(s) can be disposed of, for example by disposal at sea, in a disposal well, or in a wastewater pond.

### EXAMPLES

The present invention is further defined in the following Examples. It should be understood that these Examples, while indicating preferred aspects of the invention, are given by way of illustration only. From the above discussion and these examples, one skilled in the art can ascertain the essential characteristics of this invention, and without departing from the spirit and scope thereof, can make various changes and modifications of the invention to adapt it to various uses and conditions.

### Example 1

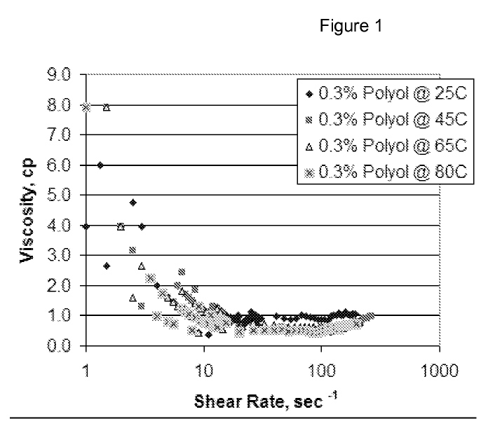

Cerenol™ H500 (homopolymer of 1,3-propanediol, DuPont de Nemours & Co., Inc., Wilmington, Del.) was dissolved in deionized water to a concentration of 0.3 weight percent. The viscosity was measured as a function of shear rate using a Brookfield DV-II+ Pro instrument using a UL adaptor with water jacketed cup and remote temperature detection probe (Brookfield Engineering Laboratories, Inc., Middleboro, Mass.). The instrument was controlled using Rheocal software v2.7. The shear rate was varied from 1 sec⁻¹ to 250 sec⁻¹ at 25, 45, 65 and 80° C. The raw data was smoothed by doing a three point average, and the results are shown in FIG. 1, where “polyol” refers to Cerenol™ H500.

### Example 2

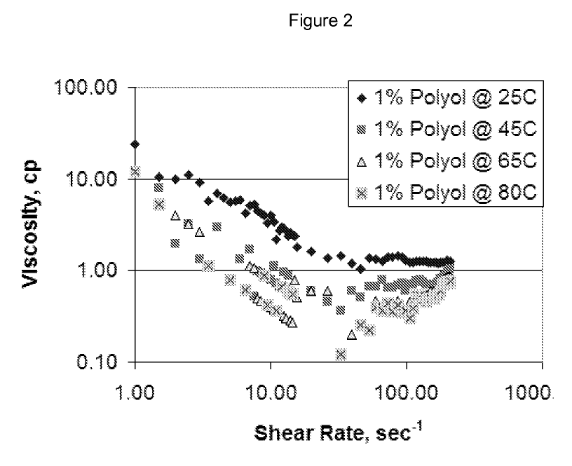

Cerenol™ H500 was dissolved in deionized water to a concentration of 1 weight percent. The viscosity was measured as a function of shear rate using a Brookfield DV-II+ Pro instrument using a UL adaptor with water jacketed cup and remote temperature detection probe (Brookfield Engineering Laboratories, Inc., Middleboro, Mass.). The instrument was controlled using Rheocal software v2.7. The shear rate was varied from 1 sec⁻¹ to 250 sec⁻¹ at 25, 45, 65 and 80° C. The raw data was smoothed by doing a three point average, and the results are shown in FIG. 2, wherein “polyol” refers to Cerenol™ H500.

### Example 3

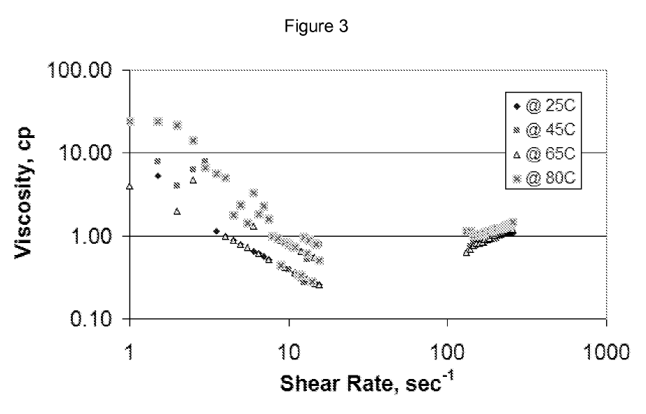

1,3-Propanediol monomer (DuPont de Nemours & Co., Inc.) was dissolved in deionized water to a concentration of 1 weight percent. The viscosity was measured as a function of shear rate using a Brookfield DV-II+ Pro instrument using a UL adaptor with water jacketed cup and remote temperature detection probe (Brookfield Engineering Laboratories, Inc., Middleboro, Mass.). The instrument was controlled using Rheocal software v2.7. The shear rate was varied from 1 sec⁻¹ to 250 sec⁻¹ at 25, 45, 65 and 80° C. The raw data was smoothed by doing a three point average, and the results are shown in FIG. 3.

### Example 4

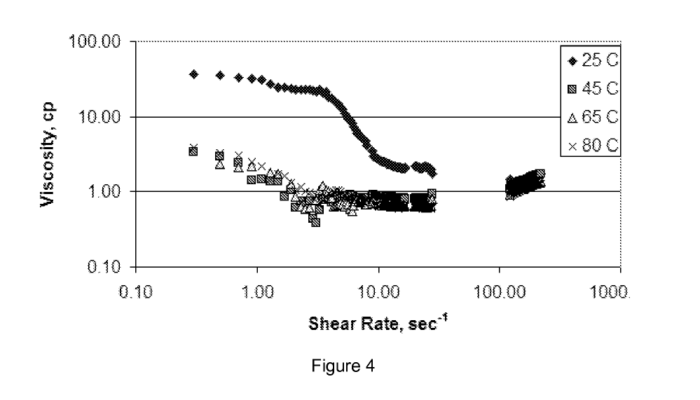

Cerenol™ H500 homopolymer was dissolved in synthetic sea water to a concentration of 1 weight percent. Synthetic sea water was acquired from EMD Chemicals Inc, Gibbstown N.J., Part number GC0118/1, lot#7050. The viscosity was measured as a function of shear rate using a Brookfield DV-II+ Pro instrument using a UL adaptor with water jacketed cup and remote temperature detection probe (Brookfield Engineering Laboratories, Inc., Middleboro, Mass.). The instrument was controlled using Rheocal software v2.7. The shear rate was varied from 1 sec⁻¹ to 250 sec⁻¹ at 25, 45, 65 and 80° C. The raw data was smoothed by doing a three point average, and the results are shown in FIG. 4.

### Example 5

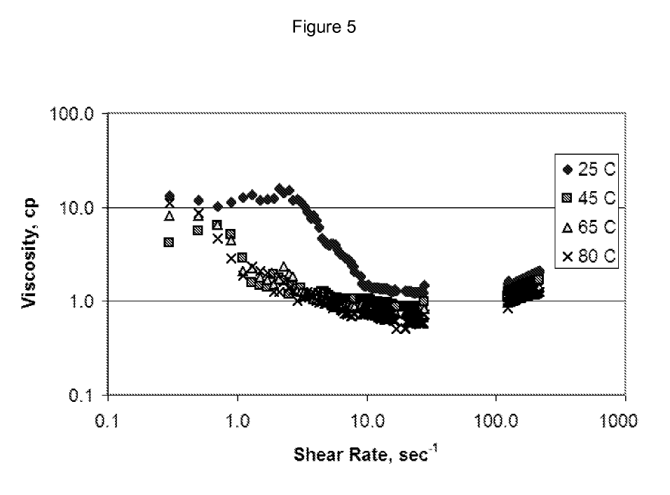

Cerenol™ H500 homopolymer was dissolved in synthetic sea water to a concentration of 0.3 weight percent. Synthetic sea water was acquired from EMD Chemicals Inc, Part number GC0118/1, lot#7050. The viscosity was measured as a function of shear rate using a Brookfield DV-II+ Pro instrument using a UL adaptor with water jacketed cup and remote temperature detection probe (Brookfield Engineering Laboratories, Inc., Middleboro, Mass.). The instrument was controlled using Rheocal software v2.7. The shear rate was varied from 1 sec⁻¹ to 250 sec⁻¹ at 25, 45, 65 and 80° C. The raw data was smoothed by doing a three point average, and the results are shown in FIG. 5.

### Example 6

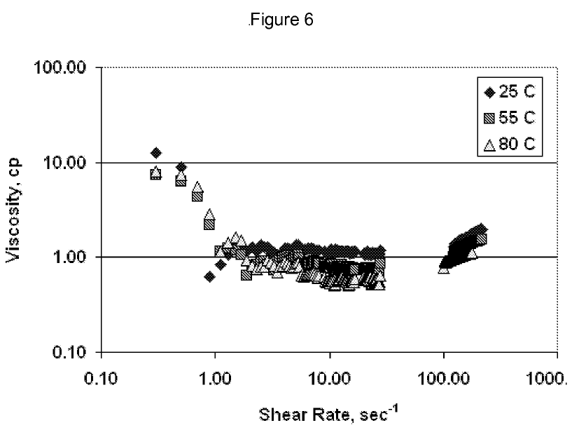

Cerenol™ C500 dipolymer with 12.8 mole % ethane diol was dissolved in synthetic sea water to a concentration of 0.1 weight percent. Synthetic sea water was acquired from EMD Chemicals Inc, Part number GC0118/1, lot#7050. The viscosity was measured as a function of shear rate using a Brookfield DV-II+ Pro instrument using a UL adaptor with water jacketed cup and remote temperature detection probe (Brookfield Engineering Laboratories, Inc., Middleboro, Mass.). The instrument was controlled using Rheocal software v2.7. The shear rate was varied from 0.3 sec⁻¹ to 250 sec⁻¹ at 25, 55 and 80° C. The raw data was smoothed by doing a three point average, and the results are shown in FIG. 6.

### Example 7

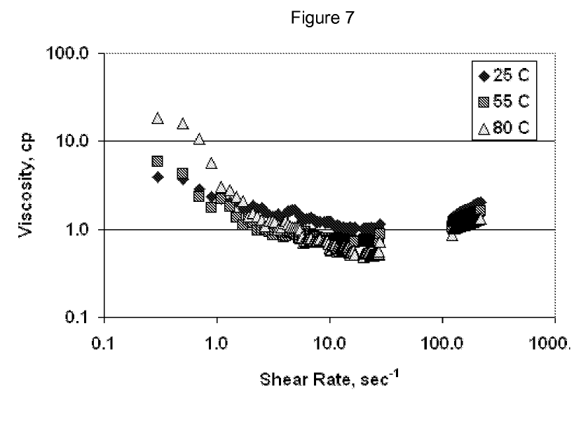

Cerenol™ H1150 homopolymer was dissolved in synthetic sea water to a concentration of 0.1 weight percent. Synthetic sea water was acquired from EMD Chemicals Inc, Part number GC0118/1, lot#7050. The viscosity was measured as a function of shear rate using a Brookfield DV-II+ Pro instrument using a UL adaptor with water jacketed cup and remote temperature detection probe (Brookfield Engineering Laboratories, Inc., Middleboro, Mass.). The instrument was controlled using Rheocal software v2.7. The shear rate was varied from 0.3 sec⁻¹ to 250 sec⁻¹ at 25, 55 and 80° C. The raw data was smoothed by doing a three point average, and the results are shown in FIG. 7.

What is claimed is:

1. A method for recovering oil from a reservoir by waterflooding, comprising:
(a) introducing an aqueous flooding fluid into the reservoir, wherein at least one portion of said flooding fluid comprises one or more members of the group consisting of 1,3-propanediol; an oligomer of 1,3-propanediol; a homopolymer of 1,3-propanediol; and a heteropolymer of 1,3-propanediol, wherein said heteropolymer is synthesized using at least one C₂ through C₁₂ comonomer diol; and
(b) displacing oil in the reservoir with said flooding fluid into one or more production wells, whereby the oil is recoverable.

2. The method of claim 1, further comprising, recovering a portion of said flooding fluid, and injecting the recovered flooding fluid into the reservoir.

3. The method of claim 2, wherein said recovered flooding fluid is supplemented with one or more members of the group consisting of 1,3-propanediol; an oligomer of 1,3-propanediol; a homopolymer of 1,3-propanediol; and a heteropolymer of 1,3-propanediol, wherein said heteropolymer is synthesized using at least one C₂ through C₁₂ comonomer diol; prior to reinjection.

4. The method of claim 1 or claim 3, wherein said one or more members of the group consisting of 1,3-propanediol; an oligomer of 1,3-propanediol; a homopolymer of 1,3-propanediol; and a heteropolymer of 1,3-propanediol, wherein said heteropolymer is synthesized using at least one C₂ through C₁₂ comonomer diol; are added at a concentration of about 0.007% to about 3% by weight relative to the weight of the at least one portion of flooding fluid.

5. The method of claim 1, wherein said flooding fluid is disposable.

6. The method of claim 5, wherein the said disposable flooding fluid is disposed of at sea, in a disposal well, or in a wastewater pond.

7. The method of claim 1, wherein said aqueous flooding fluid further comprises sea water, brine, production water, water recovered from an underground aquifer, or surface water from a stream, river, pond or lake.

8. The method of claim 1, wherein said comonomer diol is selected from the group consisting of 1,2-ethanediol, 2-methyl-1,3-propanediol, 2,2′-dimethyl-1,3-propanediol, 1-6-hexanediol, 1,7-heptanediol, 1,7-octanediol, 1,10-decanediol, and 1,12-dodecanediol.

9. The method of claim 1, wherein said 1,3-propanediol is Bio-PDO™ and said homopolymer of 1,3-propanediol is Cerenol™.

10. The method of claim 1, wherein said oligomer of 1,3-propanediol, said homopolymer of 1,3-propanediol; and said heteropolymer of 1,3-propanediol have a molecular weight of about 152 g/mole to about 3000 g/mole.

11. The method of claim 10, wherein said oligomer of 1,3-propanediol, said homopolymer of 1,3-propanediol, and said heteropolymer of 1,3-propanediol have a molecular weight of about 300 g/mole to about 1000 g/mole.

12. The method of claim 1, wherein the one or more members of the group consisting of 1,3-propanediol; an oligomer of 1,3-propanediol; a homopolymer of 1,3-propanediol; and a heteropolymer of 1,3-propanediol, wherein said heteropolymer is synthesized using at least one C₂ through C₁₂ comonomer diol; increase the shear thinning properties of the flooding fluid.

13. The method of claim 1, wherein the at least one portion of the flooding fluid exhibits a low viscosity during injection into the reservoir and a higher viscosity when flowing through the reservoir.

14. The method of claim 13, wherein the viscosity of the at least one portion of the flooding fluid comprising polyol polymer is greater than about 2 centipoise at low shear rates, wherein low shear rates are less than about 3 sec⁻¹, and wherein the viscosity of the at least one portion of the flooding fluid comprising polyol polymer is less than about 2 centipoise at high shear rates, wherein high shear rates are greater than about 50 sec⁻¹.

15. The method of claim 1, wherein the aqueous flooding fluid further comprises at least one of the group consisting of hay, sugar cane fibers, cotton seed hulls, textile fibers, shredded paper, bentonite, rubber pulp, wood shavings, nut hulls, polyacrylic amide, carboxymethylcellulose, polysaccharide, polyvinyl alcohol, polyvinyl pyrrolidone, polyacyrlic, polystyrene sulfonates, ethylene oxide polymers, methyl cellulose, starch, guar gum, gum tragacanth, sodium alginate, gum Arabic and surfactants.

16. The method of claim 15, wherein the aqueous flooding fluid further comprises starch, guar gum, sodium alginate, gum arabic or methyl cellulose.

17. The method of claim 1, wherein the sweep efficiency is improved relative to a flooding fluid without a portion of said flooding fluid comprising one or more members of the group consisting of 1,3-propanediol; an oligomer of 1,3-propanediol; a homopolymer of 1,3-propanediol; and a heteropolymer of 1,3-propanediol, wherein said heteropolymer is synthesized using at least one C₂ through C₁₂ comonomer diol.

18. The method of claim 1, wherein the water mobility decreases relative to a flooding fluid without a portion of said flooding fluid comprising one or more members of the group consisting of 1,3-propanediol; an oligomer of 1,3-propanediol; a homopolymer of 1,3-propanediol; and a heteropolymer of 1,3-propanediol, wherein said heteropolymer is synthesized using at least one C₂ through C₁₂ comonomer diol.

19. A method of making a waterflooding fluid, comprising combining one or more members of the group consisting of 1,3-propanediol; an oligomer of 1,3-propanediol; a homopolymer of 1,3-propanediol; and a heteropolymer of 1,3-propanediol, wherein said heteropolymer is synthesized using at least one C₂ through C₁₂ comonomer diol; with at least one portion of a flooding fluid.

20. An aqueous flooding fluid for enhanced oil recovery, comprising at least one or more members of the group consisting of 1,3-propanediol; an oligomer of 1,3-propanediol; a homopolymer of 1,3-propanediol; and a heteropolymer of 1,3-propanediol, wherein said heteropolymer is synthesized using at least one C₂ through C₁₂ comonomer diol; and water.

21. The aqueous flooding fluid of claim 1, wherein the one or more members of the group consisting of 1,3-propanediol; an oligomer of 1,3-propanediol; a homopolymer of 1,3-propanediol; and a heteropolymer of 1,3-propanediol, wherein said heteropolymer is synthesized using at least one C₂ through C₁₂ comonomer diol, are comprised of biologically derived 1,3-propanediol.
